(19) United States
(12) Patent Application Publication
(10) Pub. No.: US 2007/0040990 A1
(43) Pub. Date: Feb. 22, 2007

(54) Projection system and light uniforming device thereof

(75) Inventor: Yu-Chuan Chen, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/493,698

(22) Filed: Jul. 27, 2006

(30) Foreign Application Priority Data
Aug. 19, 2005 (TW) 094128345

(51) Int. Cl. G03B 21/26

(52) U.S. Cl. 353/30

(57) ABSTRACT

A light uniforming device having an input end and an output end includes a body, a first adhesive and a second adhesive. The body is hollow and has at least one joint. At least one reflective layer is applied on an inner surface of the body. The first adhesive is disposed at the joint. The second adhesive is also disposed at the joint. The heat resistance of the second adhesive is relatively larger than that of the first adhesive.

### CROSS REFERENCE TO RELATED APPLICATIONS

This Non-provisional application claims priority under 35 U.S.C. §119(a) on Patent Application No(s). 094128345 filed in Taiwan, Republic of China on August 19, 2005, the entire contents of which are hereby incorporated by reference.

### BACKGROUND OF THE INVENTION

1. Field of Invention

The invention relates to a light uniforming device and, in particular, to a light uniforming device for a projection system.

2. Related Art

The projection systems are divided into three types including a liquid crystal display (LCD) type, a liquid crystal on silicon (LCOS) type, and a digital light processing (DLP) type. The DLP type has several advantages, including high brightness, accurate tone reproduction, fast response time, noise-free operation, and thin and light composition. Therefore, the DLP type is one of the most potential projection technologies recently.

As shown in FIG. 1, a digital control method and a light reflection principle are adopted in a DLP projector 1. First, the light beam emitted by a light source 10 enters a light tunnel 11 after passing through a color filter 12. Afterward, the light beam is converged by a lens assembly 13, and then projected onto to a digital micro-mirror device (DMD) 14. The tilting angles and the rotating time of several micro-mirrors on the DMD 14 controlled by driving electrodes can change the reflection directions of light. The reflected light beam is then projected by a projection unit 15 onto a screen 16 to form an image.

Herein, the conventional light tunnel 11 is a hollow pipe with an input end 111 and an output end 112. The inner wall of the light tunnel 11 is coated with a reflective layer to form a reflective wall. After the light beam emitted by the light source 10 enters the light tunnel 11 via the input end 111, the light beam is reflected many times by the reflective wall and then outputs via the output end 112. This mechanism can make the light beam more uniform.

As shown in FIGS. 1 and 2, the conventional light tunnel 11 has four glasses 113. In the assembling process of the light tunnel 11, the glasses 113 are fixed by the jig, and an adhesive 114 is then applied to the joint of each two adjacent glasses 113, so that the glasses 113 are assembled into the desired configuration. Herein, the adhesive 114 can be an ultraviolet (UV) cured resin or an UV epoxy resin.

However, because the temperature of the light beam emitted by the light source 10 is very high, the temperature in the environment may also be increased. The high temperature in the environment may decrease the strength of the adhesive 114 in the light tunnel 11 near the light source 10. Especially in a high-quality projection system, the light source needs to have higher power, which inevitably increases the temperature of the light beam emitted from the light source.

In view of this, besides improving the heat dissipation efficiency in the projection systems, how to provide a projection system with a light tunnel that has higher heat resistance is also very important.

### SUMMARY OF THE INVENTION

In view of the foregoing, the invention is to provide a projection system and a light uniforming device thereof with high heat resistance.

To achieve the above, a light uniforming device of the invention having an input end and an output end includes a hollow body, a first adhesive and a second adhesive. The body has at least one joint. At least one reflective layer is applied on an inner surface of the body. The first and the second adhesive are disposed at the joint. The heat resistance of the second adhesive is relatively larger than that of the first adhesive.

To achieve the above, a projection system of the invention includes a light source, a light uniforming device, an optical modulation assembly and a projection unit. The light source emits a light beam. The light uniforming device has an input end and an output end. The light uniforming device includes a hollow body, a first adhesive, and a second adhesive. The body has at least one joint. At least one reflective layer is applied on an inner surface of the body, and the first adhesive and the second adhesive are disposed at the joint. The heat resistance of the second adhesive is relatively larger than that of the first adhesive. The optical modulation assembly modulates the light beam output from the light uniforming device. The projection unit receives the light beam modulated by the optical modulation assembly and projects the light beam to a screen for forming an image.

As mentioned above, the projection system and the light uniforming device thereof in the invention use a plurality of adhesives with different heat resistances at the joint of the body. That is, the body is composed of at least one optical device and the joint on the body is applied with different adhesives. In particular, the adhesive with low heat resistance can be an UV cured resin or an UV epoxy resin, and the adhesive with high heat resistance can be a silicon gel, a ceramic gel, or an inorganic gel. The adhesive with low heat resistance provides the basic connecting force for quickly and precisely fixing the light uniforming device. The adhesive with high heat resistance can be disposed at the input end, the output end or both of the light uniforming device, and the total length of the adhesive with high heat resistance is larger than that of the adhesive with low heat resistance. Besides enhancing the connecting strength of the structure, the adhesive with higher heat resistance also provides the better connecting strength at high temperatures. In comparison with the prior art, the use of the adhesive with high heat resistance reduces the possibility of disruption of the light uniforming device at high temperatures. Therefore, the projection system is more heat resistant.

### BRIEF DESCRIPTION OF THE DRAWINGS

The invention will become more fully understood from the detailed description given herein below illustration only, and thus is not limitative of the present invention, and wherein:

FIG. 1 is a schematic view of the conventional projection system;

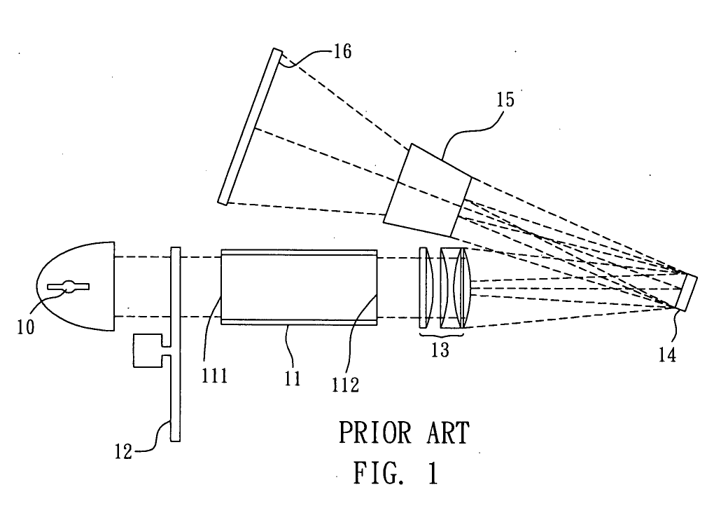

FIG. 2 is a schematic view of the conventional light uniforming device;

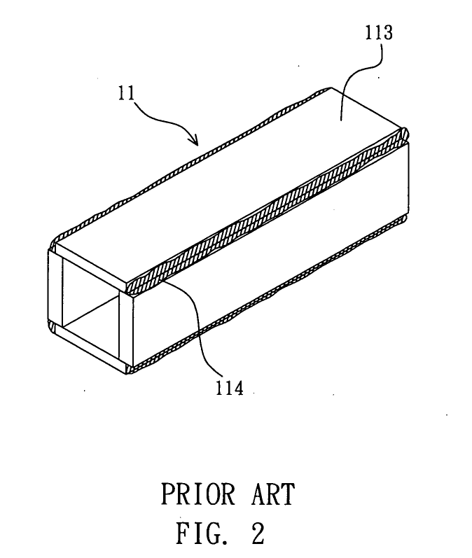

FIG. 3 is a schematic view of the light uniforming device according to a preferred embodiment of the invention;

FIG. 4 is a schematic view of the light uniforming device according to another preferred embodiment of the invention;

FIG. 5 is the a schematic view of the light uniforming device according to still another the preferred embodiment of the invention; and

FIG. 6 is a schematic view of the projection system according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

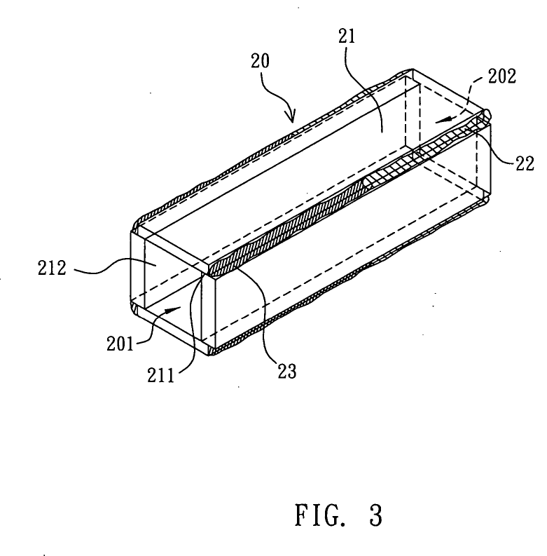

As shown in FIG. 3, a light uniforming device 20 according to a preferred embodiment of the invention includes a body 21, a first adhesive 22, and a second adhesive 23. The light uniforming device 20 has an input end 201 and an output end 202. The light uniforming device 20 can be a light tunnel, a light integration rod or a light pipe.

The body 21 is hollow and has at least one joint 211. At least one reflective layer is applied on an inner surface 212 of the body 21. The material of the reflective layer can be metal, alloy or a dielectric material. The body 21 is assembled by at least one optical device, and the joint 211 is the junction where the optical device is assembled. In this embodiment, the body 21 is a hollow structure assembled by four optical devices with four joints 211. Herein, the optical devices are reflective mirrors, and a reflective surface of each optical device is one of the inner surface 212 of the body 21.

The first adhesive 22 is disposed at the joint 211. In this embodiment, the first adhesive 22 can be an UV cured resin, an UV epoxy resin, or their mixture.

The second adhesive 23 is also disposed at the joint 211. The heat resistance of the second adhesive 23 is relatively larger than that of the first adhesive 22. That is, the joint strength of the second adhesive 23 at the high temperature is higher than that of the first adhesive 22. In this embodiment, the second adhesive 23 can be a silicon gel, a ceramic gel, or an inorganic gel.

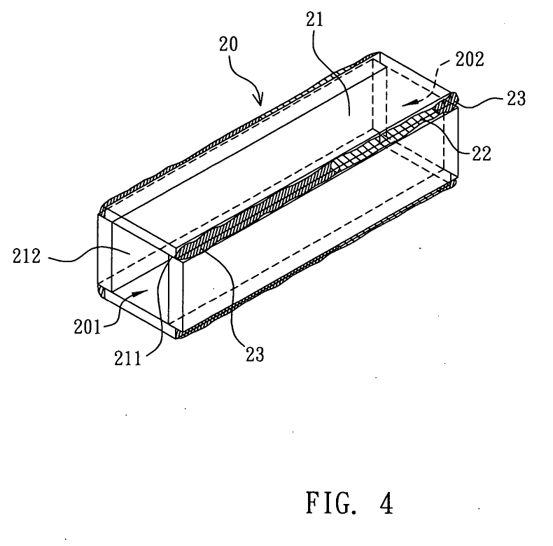

As shown in FIG. 3, the first adhesive 22 is applied adjacent to the second adhesive 23 at the joint 211. The first adhesive 22 provides the connecting force for quickly and precisely fixing the optical devices, and the second adhesive 23 strengthens the connecting force among the optical devices, particularly in a high-temperature environment. The invention is not limited by this embodiment. Either a spacer is between the first adhesive 22 and the second adhesive 23 (not shown) or the second adhesive 23 covers all or part of the first adhesive 22 (not shown)—these designs having the same function as mentioned hereinabove—are fallen within the scope of the invention. The second adhesive 23 can be disposed next to the input end 201 or the output end 202. The length of the second adhesive 23 is longer than that of the first adhesive 22 so as to make the light uniforming device 20 more resistant to the high temperature. Because of the good heat resistance property of the second adhesive 23, the input end 201 or the output end 202 with the lower connecting force resulted from overheating can be prevented. Besides, the second adhesive 23 can also be disposed both at the input end 201 and the output end 202 (as shown in FIG. 4) to provide balanced connecting force in the high temperature environment. The length of the second adhesive 23 can be adjusted according to practical needs in order to further enhance the connecting strength of the structure.

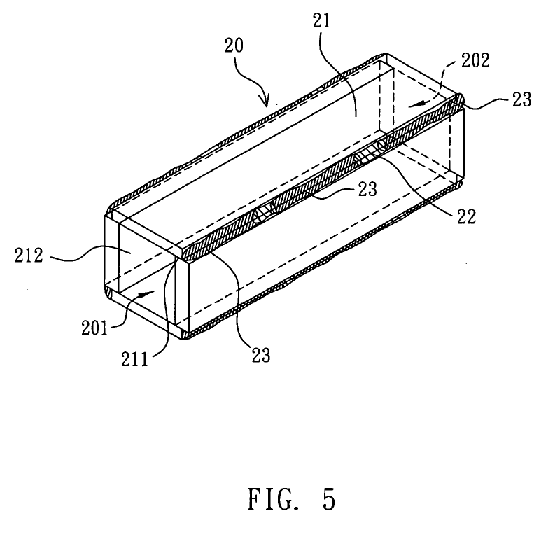

As shown in FIG. 5, the first adhesive 22 is applied at two predetermined places of each joint 211 formed by two adjacent optical devices. Afterwards, the second adhesive 23 are applied at the rest parts of the joints 211. The total length of the second adhesive 23 is larger than that of the first adhesive 22. Thus, the light uniforming device 20 with the better heat resistance can be provided.

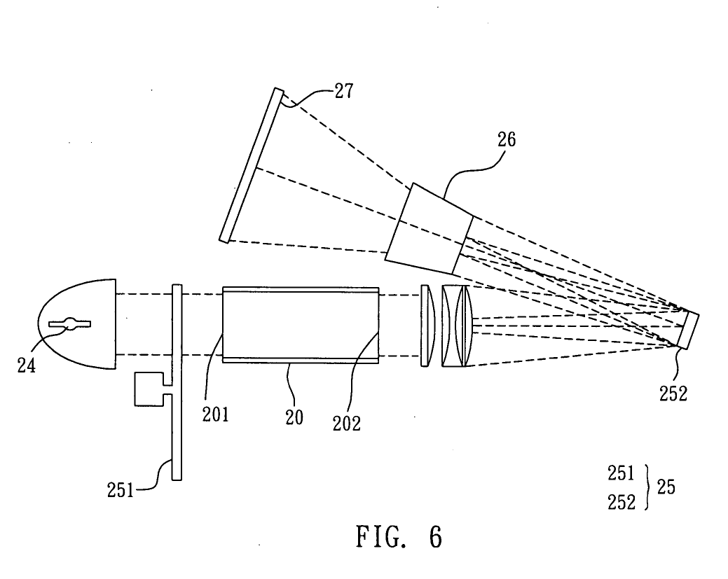

Please refer to FIG. 6, a projection system 2 according to a preferred embodiment of the invention includes a light source 24, a light uniforming device 20, an optical modulation assembly 25, and a projection unit 26.

The light source 24 emits a light beam. The light uniforming device 20 is hollow and has an input end 201 and an output end 202. The light beam passes through the light uniforming device 20 via the input end 201 and then emits out of the light uniforming device 20 via the output end 202, so that the light beam can be converged and uniformed.

In this embodiment, the light uniforming device 20 has the same features, materials and functions as mentioned hereinabove, so detailed description thereof will be omitted.

The optical modulation assembly 25 modulates the light beam output from the light uniforming device 20. Herein, the optical modulation assembly 25 includes a filter 251 and a DMD 252. The filter 251 is used to filter the light beam from the light uniforming device 20. The DMD 252 is used to receive the light beam passing through the filter 251 and controls the propagating direction of the light beam.

The projection unit 26 receives the light beam modulated by the optical modulation assembly 25, and then amplifies it. Afterward, the projection unit 26 projects the light beam to a screen 27 for forming an image.

In summary, the projection system and the light uniforming device thereof in the invention use a plurality of adhesives with different heat resistances at the joint of the body. That is, the junction of the body composed of at least one optical device is applied with different adhesives to form the light uniforming device. In particular, the adhesive with low heat resistance can be an UV cured resin or an UV epoxy resin, and the adhesive with high heat resistance can be a silicon gel, a ceramic gel, or an inorganic gel. The adhesive with low heat resistance provides the basic connecting force for quickly and precisely fixing the light uniforming device. The adhesive with high heat resistance is disposed at the input end, the output end or both of the light uniforming device, and the total length of the adhesive with high heat resistance is larger than that of the adhesive with low heat resistance. Besides enhancing the connecting strength of the structure, the invention also provides the better connecting strength at high temperatures. In comparison with the prior art, the use of the adhesive with high heat resistance reduces the possibility of disruption of the light uniforming device at high temperatures. Therefore, the projection system is more heat resistant.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A light uniforming device having an input end and an output end, comprising:
a hollow body having at least one joint and provided with at least one reflective layer on an inner surface thereof;
a first adhesive disposed at the joint; and
a second adhesive disposed at the joint, wherein the heat resistance of the second adhesive is relatively higher than that of the first adhesive.

2. The light uniforming device of claim 1, wherein the first adhesive is applied adjacent to the second adhesive.

3. The light uniforming device of claim 1, wherein the second adhesive is applied at a position near the input end, the output end or both.

4. The light uniforming device of claim 1, wherein the second adhesive covers completely or partially the first adhesive.

5. The light uniforming device of claim 1, wherein the first adhesive is an ultraviolet (UV) cured resin, a UV epoxy resin, or a mixture thereof.

6. The light uniforming device of claim 1, wherein the second adhesive is a silicon gel, a ceramic gel, an inorganic gel, and a mixture thereof.

7. The light uniforming device of claim 1, wherein the material of the reflective layer is metal, alloy, or a dielectric material.

8. The light uniforming device of claim 1, wherein the light uniforming device is a light tunnel, a light integration rod or a light pipe.

9. The light uniforming device of claim 1, wherein the total length of the second adhesive is relatively larger than that of the first adhesive.

10. The light uniforming device of claim 1, wherein the first and second adhesives are alternately applied at the joint.

11. A projection system comprising:
a light source emitting a light beam;
a light uniforming device having an input end and an output end, wherein the light uniforming device includes a hollow body, a first adhesive, and a second adhesive; the body has at least one joint and at least one reflective layer disposed on an inner surface thereof, the first adhesive and the second adhesive are disposed at the joint, and heat resistance of the second adhesive is relatively higher than that of the first adhesive;
an optical modulation assembly modulating the light beam output from the light uniforming device; and
a projection unit receiving the light beam modulated by the optical modulation assembly and projecting the light beam to a screen for forming an image.

12. The projection system of claim 11, wherein the first adhesive is applied adjacent to the second adhesive.

13. The projection system of claim 11, wherein the second adhesive is applied at a position near the input end, the output end or both.

14. The projection system of claim 11, wherein the second adhesive completely or partially covers the first adhesive.

15. The projection system of claim 11, wherein the first adhesive is an ultraviolet (UV) cured resin, a UV epoxy resin, or a mixture thereof.

16. The projection system of claim 11, wherein the second adhesive is a silicon gel, a ceramic gel, an inorganic gel, or a mixture thereof.

17. The projection system of claim 11, wherein the material of the reflective layer is metal, alloy, or a dielectric material.

18. The projection system of claim 11, wherein the light uniforming device is a light tunnel, a light integration rod or a light pipe.

19. The projection system of claim 11, wherein the total length of the second adhesive is relatively larger than that of the first adhesive.

20. The projection system of claim 11, wherein the first and second adhesives are alternately applied at the joint.
